(19) United States
(12) Patent Application Publication
(10) Pub. No.: US 2025/0285315 A1
(43) Pub. Date: Sep. 11, 2025

(54) Multi-Modal Localization

(71) Applicant: Skyline Nav Ai Inc., Cambridge, MA (US)

(72) Inventors: Kanwar Singh, Cambridge, MA (US); Rajeev Surati, Cambridge, MA (US); Sachin Shah, Cambridge, MA (US); James Ian Davis, Cambridge, MA (US); Elizabeth Rose Girling, Cambridge, MA (US); Daniel Mireles Sarni, Cambridge, MA (US)

(21) Appl. No.: 19/073,770

(22) Filed: Mar. 7, 2025

Related U.S. Application Data
(60) Provisional application No. 63/562,959, filed on Mar. 8, 2024.

(51) Int. Cl. G06T 7/70; G06T 7/246; G06T 17/20; G06V 10/74; G06V 20/13; G06V 20/17

(52) U.S. Cl. CPC G06T 7/70; G06T 7/246; G06T 17/20; G06V 10/761; G06V 20/13; G06V 20/17; G06V 2201/07

(57) ABSTRACT

A method for localizing a device includes determining a first position estimate for the device using acquired skyline data and determining second position estimate using an object model representing expected representing locations of instances of objects from multiple object classes. A combined position estimate is then determined based at least in part on the first and second position estimates.

### CROSS-REFERENCES TO RELATED APPLICATIONS

This application claims the benefit of U.S. Provisional Application No. 63/562,959 filed Mar. 8, 2024, the entire contents of which are incorporated herein by reference.

### BACKGROUND OF THE INVENTION

Localization approaches that use satellite signals and/or local radio-frequency terrestrial “beacons” have been used for accurate localization of devices. The most well-known may be the Global Positioning System (GPS), which uses a constellation of satellites for localization. Wi-Fi access point signals have been used as terrestrial beacons by mapping out their locations in association with transmitted identification information (e.g., service set identification, SSID). While such approaches may be useful, they may have limitations such a poor signal availability and/or multipath in urban environments and in areas without satellite signal availability, lack of mapping of “beacons” in an area of interest, excessive computation or power consumption in radio signal acquisition, or jamming of such signals. Furthermore, GPS is unavailable on celestial bodies such as the Moon and Mars.

Localization by skyline sensing has been used in situations where satellite or terrestrial radio signal references are not available. For example, such an approach is described in U.S. Pat. No. 11,678,140, “Localization by using skyline data,” issued on Jun. 13, 2023, which is incorporated herein by reference (and referred to herein as the '140 patent). Localization using three-dimensional (3D) models of an area around an individual may be accomplished by capturing an image locally and pre-generating images in a small region around the person's location. Then, by comparing and selecting the best-matching images, it is possible to predict the individual's exact location more precisely. The computation required for image generation and comparison is simplified in the '140 patent because the prediction and matching are reduced to a one-dimensional problem. This simplification often involves varying an azimuth from 0 to 360 degrees and reducing the elevation angle, thus reducing the problem to tens of values per potential x, y, z location, as opposed to hundreds of thousands or more.

### SUMMARY OF THE INVENTION

Aspects described herein relate to a Visual Positioning System (VPS) that mitigates challenges that arise in GPS denied or dead zones by leveraging computer vision algorithms, 2D and 3D geospatial datasets, and image-based matching techniques to enable precise geolocation independent of GPS, cellular, or RF signals. For example, aspects perform geospatial localization in GPS-denied or degraded environments, including urban canyons, mountainous regions, subterranean infrastructure, occluded aerial regions, and planetary surfaces where satellite-based navigation is infeasible. Ultimately, aspects help drones, aircraft, ground vehicles and shipping vessels navigate independently of GPS, leveraging computer vision capabilities that are fused with an onboard camera, IMU, and other sensors.

In a general aspect, the VPS disclosed herein provides a multi-modal geolocation framework that uses computer vision and geospatial dataset analysis to determine absolute and relative position. In some aspects, the system includes an aerial VPS component that matches downward-facing imagery against geo-referenced satellite datasets, a skyline VPS that extracts horizon contours and matches them with Digital Surface Model (DSM)-derived skyline maps for localization, a landmark VPS that employs machine learning-based feature detection and optical character recognition (OCR) for positioning via building signage, road signs, and facade-based textual markers, and a mesh VPS that utilizes texture-mapped 3D meshes to perform structure-from-motion (SfM) image matching, achieving sub-meter accuracy. Furthermore, some aspects integrate multi-modal fusion techniques, incorporating inertial measurement unit (IMU) data, altimeters, and semantic scene understanding to constrain search areas and improve computational efficiency.

In another general aspect, a method for localizing a device includes acquiring image data from the device, the image data including data representing a skyline visible from the device at its position in an environment and data representing instances of objects from multiple object classes in the environment. A first position estimate is determined by computing data representing expected skylines at one or more putative positions, matching the acquired skyline data with the expected skylines at the putative positions, and determining the first position estimate based on the best-matching putative position. A second position estimate is determined by accessing an object model representing locations of instances of objects from multiple object classes, computing data representing the presence of instances of objects in the acquired image data, computing expected object locations visible from the one or more putative positions, and determining the second position estimate by matching the presence of instances of objects with the expected object locations. A combined position estimate is then determined based at least in part on the first and second position estimates.

Aspects may include one or more of the following features.

Computing the data representing the presence of objects may include performing text recognition on portions of the image data associated with at least some instances of objects to generate text data, which is used to refine the second position estimate. The first position estimate may be used to access the object model, and the second position estimate may be used to compute expected skylines at the one or more putative positions.

The image data may include nadir-view aerial imagery, and the method may determine a third position estimate by accessing geo-referenced satellite image data representing locations of keypoints, computing keypoint locations in the acquired image data, and determining the third position estimate by matching keypoints in the acquired image data with those in the satellite data. The third position estimate may be determined by tracking keypoints in the acquired image data over time. The combined position estimate is further based on the third position estimate.

Skyline matching may include computing a similarity score, which may account for changes in expected skylines. Additionally, similarity scores may be weighted within a neighborhood of similarity scores based on their consistency. The combined position estimate may also incorporate data from additional sensors, such as an inertial measurement unit, a global positioning system, an altimeter, or a barometer.

The image data may include ground-level imagery, and the method may determine a third position estimate by receiving geo-referenced three-dimensional mesh data, processing the data to generate reference images with depth information, computing keypoint locations in the acquired image data, and determining the third position estimate based on matches between keypoints in the acquired image data and keypoints in the reference images. The combined position estimate is further based on the third position estimate.

The device may be an unmanned aerial vehicle or an autonomous ground vehicle.

In another general aspect, a method for localizing a device includes acquiring image data representing a skyline visible from the device, accessing a surface model of the environment, computing expected skylines at one or more putative positions, matching the acquired skyline data with expected skylines, and determining a position estimate based on the best-matching putative position. The surface model may be a multi-scale representation of the environment, with different regions accessed at different resolutions, and expected skylines may be determined using data from multiple resolutions.

In yet another general aspect, a method includes acquiring image data representing a skyline and object locations visible from the device, accessing both a surface model and an object model, computing expected skylines and expected object locations, matching the acquired skyline and object data with the expected data, and determining a position estimate based on the best-matching putative position. The surface and object models may be multi-scale representations, with different regions accessed at different resolutions, and expected skylines and object locations may be computed using multi-scale data.

Aspects may acquire data from additional sensors, and the position estimate is determined using both skyline matching and the sensor data. The sensors may include an inertial measurement unit or an altimeter.

In another general aspect, a system for localizing a device includes an input for acquiring image data from the device and one or more processors configured to determine a first position estimate based on skyline matching, determine a second position estimate based on object matching, and determine a combined position estimate based on both position estimates. In yet another aspect, a non-transitory machine-readable medium stores instructions that, when executed, cause a processor to perform the method, including acquiring image data, determining a first and second position estimate, and computing a combined position estimate.

A number of techniques described herein extend approaches described in the '140 patent or are applicable to other skyline localization approaches.

In another general aspect, use of semantic segmentation (sometimes called object detection, landmark locator—the terms may be used interchangeably herein) in a field of view in addition to a skyline information may be used to enhance accuracy of localization and/or reduce computation requirements of the localization. Note that reduction in computation required typically translates directly to reduced electrical power and compute requirements, which can be very important for portable/mobile devices (e.g., smartphones, augmented reality headsets, autonomous ground and aerial vehicles, uncrewed maritime vessels, lunar rovers etc.) by extending operating time and/or reducing battery size or weight requirements.

In another general aspect, terrain data is represented using lower spatial resolution distant from the device being localized that close to the device. It should be recognized that features of the environment that impact the skyline view from a location may not need to have as great a spatial resolution if they are distant as compared to their being close because a variable of importance is a change of spatial angle to the feature with changes of location. In a particular embodiment of this approach, terrain or 3D or height data is stored in a quadtree data structure (see, e.g., Wikipedia “Quadtree” accessed from en.wikipedia.org/wiki/Quadtree on Mar. 8, 2024), with more distance quads being represented with lower spatial resolution (e.g., lower horizontal “x-y” resolution, lower 3D “x-y-z” resolution and/or lower height/altitude “z” resolution).

In another general aspect, the skyline localization approaches are integrated with other localization modalities (e.g., inertial navigation, approximate or errorful position with satellite or Wi-Fi signals, visual odometry, altimetry, magnetometry, etc.) to improve overall tracking performance.

Aspects may have one or more of the following advantages.

Aspects advantageously achieve robust GPS-independent localization using passive optical sensors, precomputed geographic datasets, and multi-modal spatial referencing techniques.

The VPS advantageously dynamically adapts to environmental conditions, employing probabilistic models to select the most reliable localization method based on the availability and quality of data. Aspects advantageously provide a multi-layered, adaptive positioning framework that dynamically selects the best of several localization methods.

Some aspects advantageously correct for the urban canyon effect. GPS signals (even when combined with real time kinematic techniques) can be quite poor in urban areas. Aspects can localize better than GPS alone and can also be more cost-effective than using HD maps and images.

Aspects advantageously operate independently of real-time feature mapping (unlike SLAM), relying on precomputed geospatial reference data.

Aspects advantageously integrate skyline-matching, aerial image analysis, and 3D mesh comparisons. Aspects advantageously localize a device within meters in a few square kilometer region. Centimeter-level accuracy is feasible with higher-resolution datasets.

Aerial VPS advantageously works in works for mid-to-high altitude operations (and can even scale to space) and can operate on very large areas depending on altitude. Aspects are advantageously able to fall back to using fast relative positioning when necessary.

Landmark VPS advantageously provides high localization precision in dense urban areas (˜5 m accuracy) and works with dynamic datasets (e.g., Google Maps, OpenStreetMap, Yelp etc.) for real-time updates. Furthermore, the search area of landmark VPS can be massive, on the order of statewide without a meaningful impact on localization speed.

Skyline VPS advantageously operates in GPS-degraded environments, such as urban canyons, and is less sensitive to atmospheric conditions, as skyline contours remain stable. Furthermore, DSMs are easy and cheap to obtain for any region (e.g., planes or satellites) and the search area can be over 4 sq km without meaningful impact on localization speed. We can limit the search area to smaller areas, depending on the availability and quality of an IMU.

Mesh VPS advantageously achieves centimeter-level accuracy in structured environments, is ideal for robotic navigation, VR/AR, and autonomous drones, and works for low altitude to ground level operations with a forward-looking camera.

Other features and advantages of the invention are apparent from the following description, and from the claims.

### BRIEF DESCRIPTION OF THE DRAWINGS

FIG. 1 is a drone flying in an environment.

FIG. 2 is a visual positioning system.

FIG. 3 is an aerial visual positioning sub-system.

FIG. 4 is an image with keypoints identified.

FIG. 5 is a georeferenced satellite pyramid.

FIG. 6 is a correspondence between keypoints in a query image and a reference image.

FIG. 7 is a location determined by the aerial visual positioning sub-system.

FIG. 8 is a sequence of images of the ground.

FIG. 9 is a correspondence between keypoints in the images of FIG. 8.

FIG. 10 is a relative movement determined from the correspondence of FIG. 9.

FIG. 11 is a landmark visual positioning sub-system.

FIG. 12 is an image with landmarks identified.

FIG. 13 is a map of landmarks.

FIG. 14 is a map of observed landmarks.

FIG. 15 is a field of view for a landmark.

FIG. 16 is a field of view for a landmark, refined by depth data.

FIG. 17 is a location determined by observed landmarks.

FIG. 18 is a location determined by observed landmarks and skyline data.

FIG. 19 is a mesh visual positioning sub-system.

FIG. 20 is a mesh representation of a geographical region.

FIG. 21 is a walkable 2D map.

FIG. 22 is an RGB image and corresponding depth map.

### DETAILED DESCRIPTION

### 1 Overview

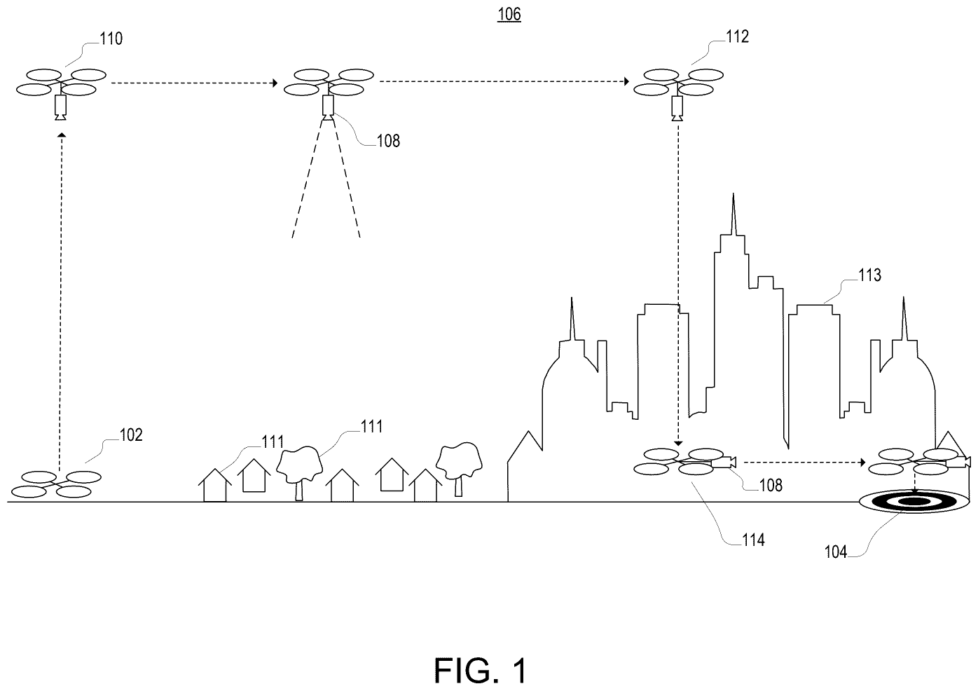

Referring to FIG. 1, a drone 100 uses a visual positioning system (VPS, not shown) to navigate from a starting position 102 to a target position 104 in a GPS-denied or GPS-degraded environment 106. Very generally, as the drone flies, it collects image data using a camera 108 (e.g., a visible/stereo camera, a fish-eye lens camera, electro-optical and infrared/thermal camera, or other suitable image sensor) and processes the image data using the VPS to localize itself in the environment 106.

As is described in greater detail below, the VPS includes multiple visual positioning sub-systems, each of which can be used independently or in combination with other visual processing sub-systems and sensors to localize the drone 100 in a variety of different operating cases. For example, when the drone 100 launches, it ascends to first position 110 at an altitude higher than any natural or human structures in the environment 106. The drone 100 flies at altitude from the first position 110 toward the target position 104 with its camera 108 pointed at the ground. Images collected by the camera 108 are processed by an aerial visual positioning sub-system, which localizes the drone 100 by matching features 111 in the images to features in georeferenced satellite imagery.

When the drone 100 reaches a second position 112, closer to the target position 104, it descends to a third position 114 closer to the ground. The drone 100 then files from the third position 114 to the target position 104 with its camera 108 pointed outward, towards buildings and other environmental features 111. Images collected by the camera 108 are processed in one or more of a skyline visual processing sub-system, a landmark visual processing sub-system, and a mesh visual processing sub-system to localize the drone (all described in greater detail below).

Very generally, the skyline visual processing sub-system localizes the drone 100 by comparing detected skyline contours 113 from the images with known elevation models or maps to estimate the drone's location. The landmark visual processing sub-system identifies landmarks (e.g., signs and streetlights) in the images and compares the identified landmarks to georeferenced landmark data to estimate the drone's location. The mesh visual processing sub-system processes the images according to texture 3D meshes (e.g., from Google Earth) of a narrowed local region to estimate the drone's location down to the centimeter.

As the drone 100 travels toward the target position 104, the surrounding environment may change. For example, in some locations skyline location information may be easily obtained (i.e. urban areas), while in other locations skyline location information is sparse but landmark location information may be easily obtained (i.e. suburban and rural areas). The visual positioning system may adapt to the changing environment by processing the image data from the camera in multiple of the sub-systems at once and selecting the localization result of the sub-systems with the greatest confidence. Alternatively, the outputs of multiple of the sub-systems may be combined or “fused” to generate an improved localization result.

Furthermore, the processing by the different visual processing sub-systems can be fused with traditional sensors such as an Inertial Measurement Unit (IMUs) to either reduce computational cost or improve accuracy (e.g., by reducing the search area to under a few hundred meters). Since the VPS is isolated from external devices, it cannot be jammed, and can even aid in detecting GPS-denied or GPS-challenged environments such as urban canyons.

### 2 Visual Positioning System

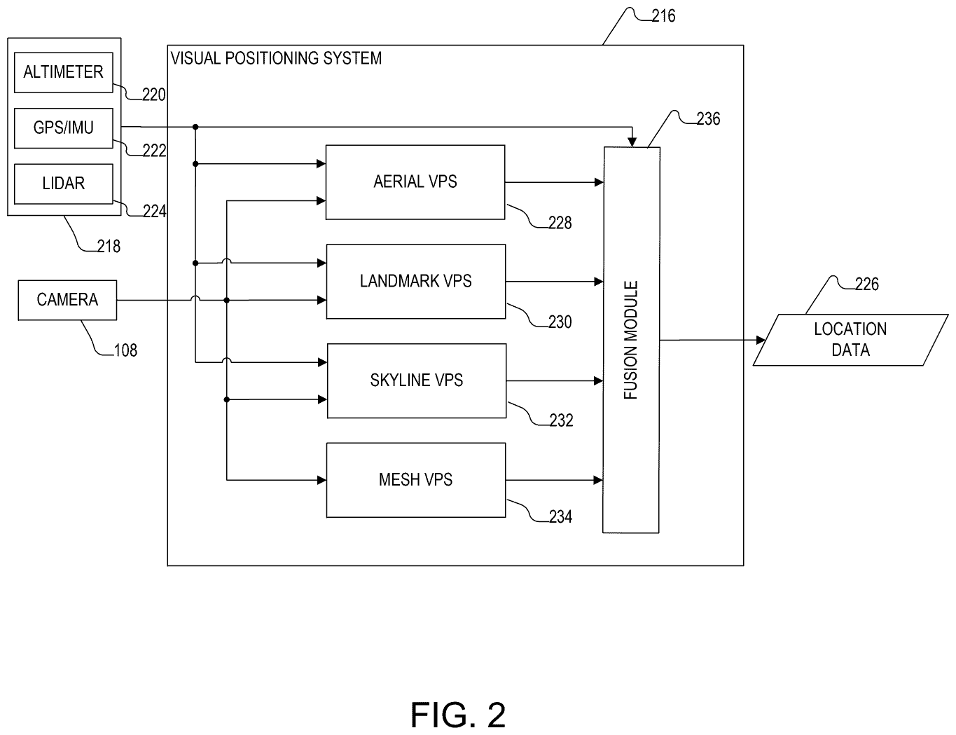

Referring to FIG. 2, in one example, the visual positioning system 216 processes image data from the camera 108 and additional sensor data from a number of sensors 218 (e.g., an altimeter 220, GPS/IMU sensors 222, a LiDAR sensor 224, barometers, and magnetometers (not shown)) to generate location data 226 representing a two or three-dimensional location of a platform (e.g., the drone 100) in space.

The visual positioning system 216 includes an aerial visual positioning sub-system 228 (i.e., the “aerial VPS”), a landmark visual positioning sub-system 230 (i.e., the “landmark VPS”), a skyline visual positioning sub-system 232 (i.e., the “skyline VPS”), a mesh visual positioning sub-system 234 (i.e., the “mesh VPS”), and a fusion module 236. In some examples, each of the visual positioning sub-systems processes the image and sensor data in parallel and provides respective location data and confidence scores (i.e., how confident the sub-system is in its location estimate) to the fusion module 236 (in some examples along with data from the sensors 218). In some examples, the fusion module 236 selects location data with the highest confidence score and outputs the selected location data as the location data 226. In other examples, the location data from the visual processing sub-systems and sensors 218 is fused using, for example, Kalman or complementary filtering, feature-level fusion techniques (e.g., principal component analysis or machine learning), or decision-level fusion techniques (e.g., Bayesian inference-based on multiple decisions). In yet other examples, only some of the visual processing sub-systems are enabled at a given time (e.g., based on location, altitude, and/or surroundings). The fusion module 236 may integrate with other localization modalities, as is described in greater detail in section 6 below, titled “Integration with Other Localization Modalities Detail.”

### 2.1 Aerial VPS

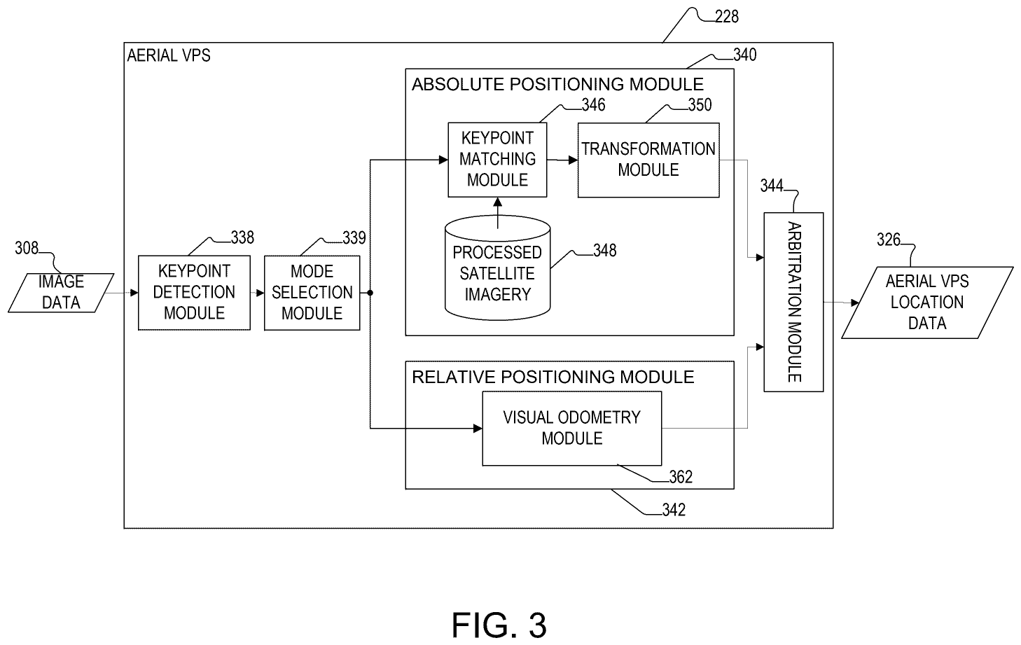

Referring to FIG. 3, in some examples, the aerial VPS 228 is effective as the drone 100 (or other platform) “flies” above the tops of all structures in the environment 106, with its camera 108 facing towards the ground. In general, a large operating area of the drone (e.g., on the scale of 10 sq km), is known a priori.

As the drone 100 files, it captures nadir-view image data 308 (i.e., with the camera 108 facing downward) and aerial VPS 228 processes the image data 308 to generate aerial VPS location data 326. In some examples, the aerial VPS sub-system 228 includes a keypoint detection module 338, a mode selection module 339, an absolute positioning module 340, a relative positioning module 342, and an arbitration module 344.

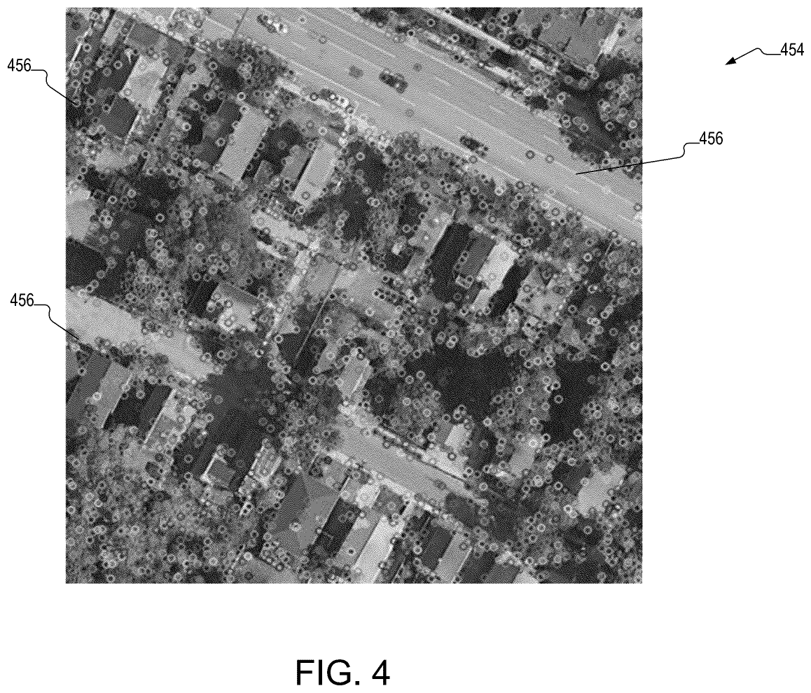

The keypoint detection module 338 processes the image data 308 to identify keypoints (e.g., corners, edges, textures, landmarks, etc.) in the image data, where the identified keypoints are represented using descriptors such as keypoint location and keypoint type. In some examples, the keypoint detection algorithm includes classical detectors like SIFT (scale-invariant feature transform) and SURF (speeded-up robust features). In other examples, neural network-based detectors like SuperGlue and LightGlue can be used as keypoint matchers. In some examples, keypoints are detected at multiple scales (e.g., at multiple levels of zoom) to increase the robustness of the system. Referring to FIG. 4, one example of a satellite image 454 is shown with multiple keypoints 456 identified.

Referring again to FIG. 3, the keypoint descriptors are provided to the mode selection module 338, which processes the keypoint descriptors to determine whether to proceed using the absolute positioning module 340 or the relative positioning module 342. In some examples, the mode selection module 339 analyzes the number and/or quality of the keypoint descriptors to determine which positioning mode to use. For example, if there are many and/or high-quality keypoints detected in the image data 308, absolute positioning is used. Alternatively, if there are few and/or low-quality keypoints detected in the image data 308, relative positioning is used. In yet other examples, both modes may be used in parallel. Based on the analysis of the mode selection module 339, the keypoint descriptors are provided to one or both of the absolute processing module 340 or the relative positioning module 342.

### 2.1.1 Absolute Positioning Mode

The absolute positioning module 340 matches the keypoint descriptors detected in the image data 308 to determine the absolute position of the drone 100 by matching the keypoint descriptors to keypoints in geo-referenced satellite imagery. In some examples, the absolute positioning module 340 includes a keypoint matching module 346, a reference dataset of processed satellite imagery 348 (e.g., precomputed multi-modal datasets including geo-registered satellite imagery, DSMs, 3D mesh reconstructions, and/or landmark annotations), and a transformation module 350.

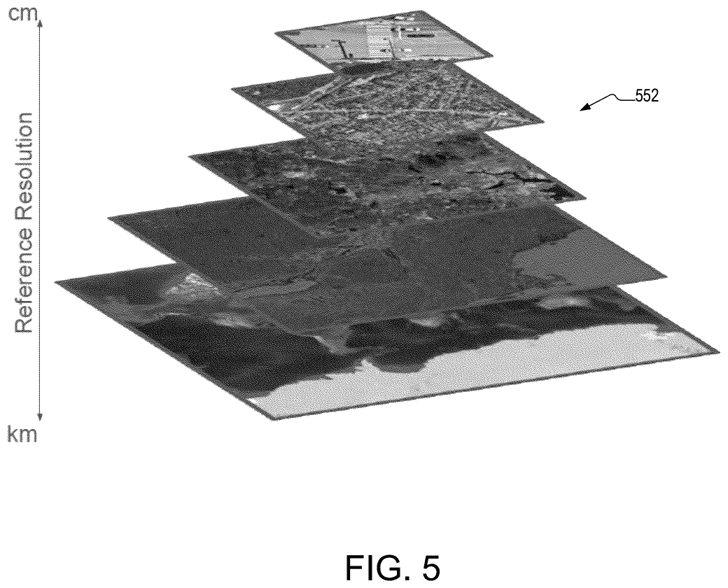

The keypoint matching module 346 receives the keypoint descriptors detected in the image data 308 and matches them to keypoints in the reference dataset of processed satellite imagery 348. Referring to FIG. 5, in some examples, the reference dataset of processed satellite imagery 348 includes a georeferenced satellite pyramid 552 of two-dimensional images at different resolutions/scales (e.g., from km to cm) that has been pre-processed to detect reference keypoints at each scale. In some examples, prior GPS or IMU data is used to constrain the reference keypoint locations that are used for matching. Furthermore, in some examples, altimeter data is used to select which resolutions/scales of the reference data are used for matching.

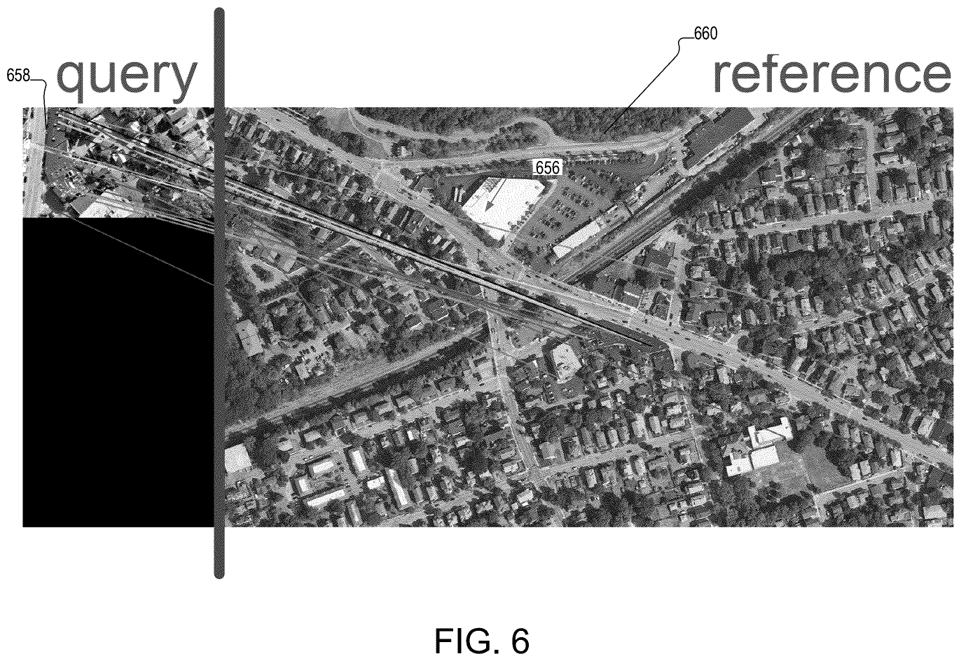

Referring again to FIG. 3, the keypoint matching module 345 detects matches between the keypoint descriptors detected in the image data and the reference keypoints using, for example, brute-force matching, FLANN (fast library for approximate nearest neighbors), cosine similarity, and neural network-based matchers such as SuperGlue and LightGlue. Referring to FIG. 6, a detected correspondence 656 between multiple keypoints in a query image 658 and a reference image 660 is illustrated.

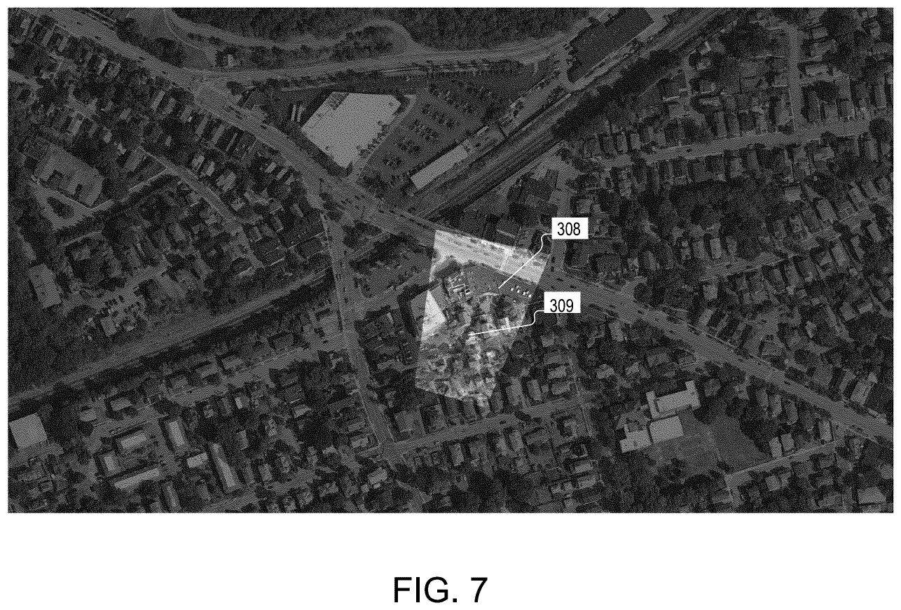

Referring again to FIG. 3, the keypoint matching data generated by the keypoint matching module is provided to the transformation module 350, which uses homography transformation matrices and epipolar geometry constraints to compute global coordinates from the image pixel space. For example, a transformation matrix is computed to convert from camera pixel coordinates to global positions based on the matches. Referring to FIG. 7, one example of image data 308 is shown mapped onto the global coordinate system of a georeferenced satellite reference image, with an estimated location 309 of the drone shown as a dot. Referring again to FIG. 3, the transformation module 350 determines an estimated location of the drone based on the global coordinates and outputs the estimated location to the arbitration module 344.

### 2.1.2 Relative Positioning Mode

The relative positioning module 342 is used when the environment 106 lacks sufficient distinguishable features to perform global visual positioning over a large area such as deserts or snow-covered regions. In some examples, the relative positioning module 342 processes the keypoint descriptors detected by the keypoint detection module 338 using a visual odometry module 362 that estimates motion and trajectory by analyzing sequential images to track keypoint changes in the image data 308 over time, estimating the location of the drone (similar to how an IMU can provide relative position updates).

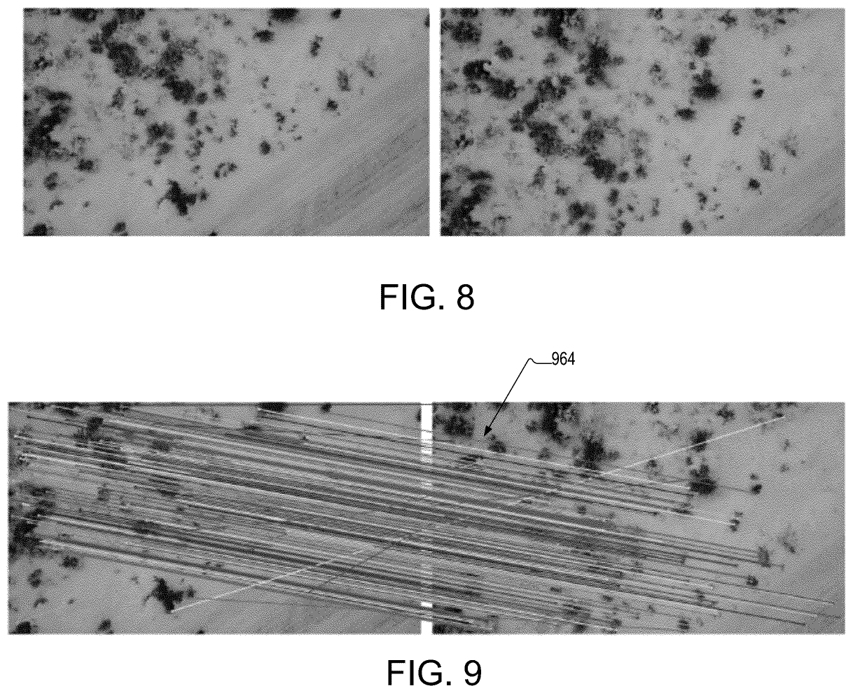

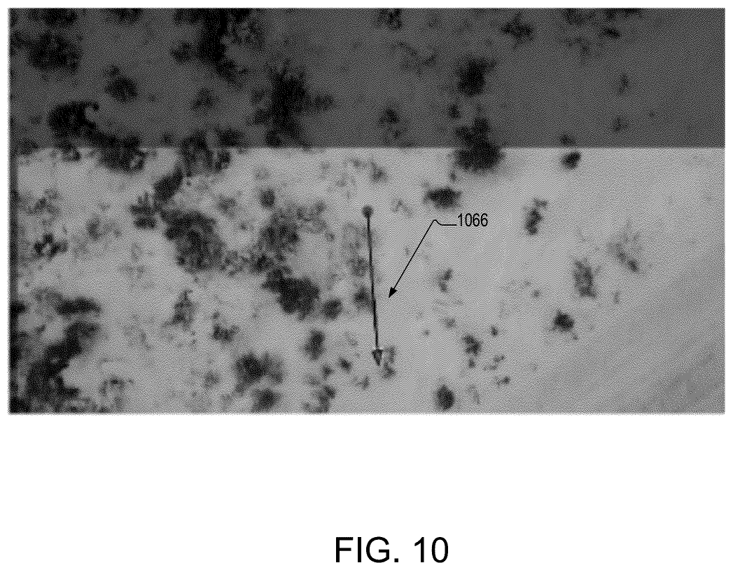

For example, in FIG. 8, two successive frames of image data are shown, where the frames do not have sufficient distinguishable features to perform absolute visual positioning by keypoint matching. In FIG. 9, a correspondence 964 between features in the two frames is identified by the visual odometry module 362. Referring to FIG. 10, a relative movement 1066 of the drone over the two frames is identified by the visual odometry module 362, based on the correspondence 964. The relative movements between frames of image data are accumulated to track the estimated location of the drone.

Referring again to FIG. 3, the estimated location of the drone determined by the visual odometry module 362 of the relative positioning module 342 is output to the arbitration module 344.

### 2.1.3 Arbitration Module

In situations where both absolute and relative estimated locations of the drone are determined and provided to the arbitration module 344, the arbitration module selects one or the other based on the confidence of the respective relative locations. Alternatively, the estimates can be combined or fused to determine the aerial VPS location data 326.

In situations where only one of the absolute and relative locations are determined, the arbitration module 344 passes the estimated location of the drone through as the aerial VPS location data 326.

### 2.2 Landmark VPS

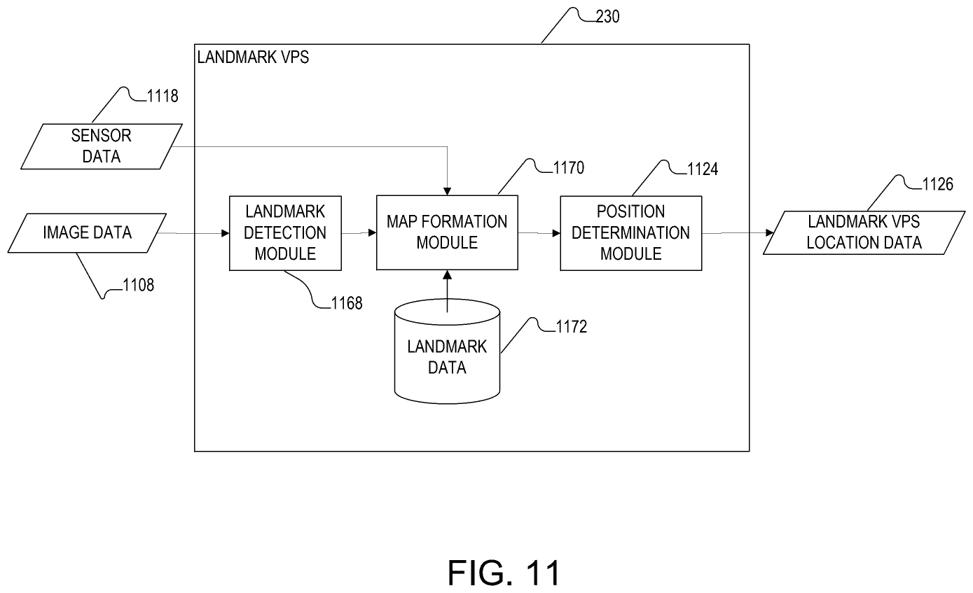

Referring to FIG. 11, in some examples, the landmark VPS 230 is used as the drone 100 (or other platform) flies or otherwise moves near ground level and between buildings, with its camera 108 facing outward towards the building facades. Landmark-based visual positioning is especially effective in areas such as suburban areas where many buildings may look structurally similar (e.g., strip malls) but have different businesses. In such cases, the combination of multiple features helps narrow down the possible location of the drone.

As the drone 100 flies, it captures horizontal view image data 1108 and the landmark VPS 230 processes the image data 1108 (and sometimes the sensor data 1118) to generate landmark VPS location data 1126. In some examples, the landmark VPS 230 includes a landmark detection module 1168, a map formation module 1170, landmark data 1172, and a position determination module 1174.

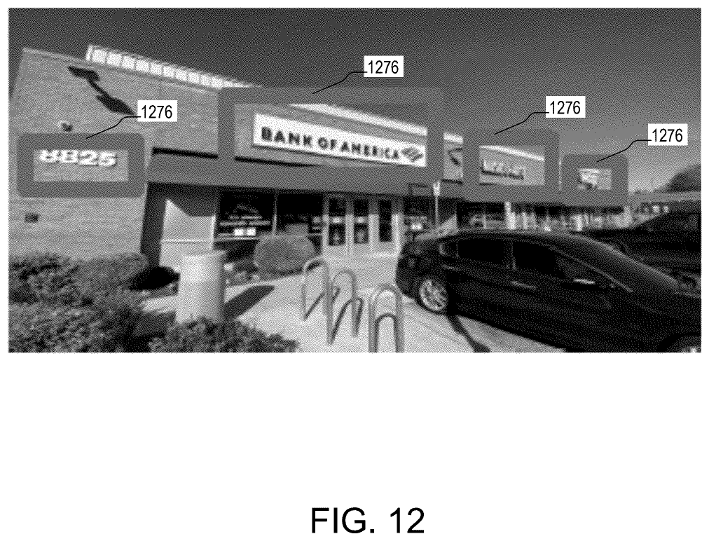

In some examples, the landmark detection module 1168 uses object detection architectures such as YOLO (you only look once), Faster R-CNN (a region-based convolutional neural network), transformer/vision language model based techniques to recognize landmark features such as signage, street names, traffic lights, house numbers, and building numbers in the image data 1108. The landmark detection module 1168 also uses OCR-based text parsing algorithms (e.g., Tesseract, Vision Transformer-based OCR) to extract relevant textual metadata (e.g., street names, business names, building numbers). For example, referring to FIG. 12, the landmark detection module 1168 has processed image data to identify landmark features 1276 including a building number, a “Bank of America” sign, and other store signs. Where possible, the text parsing algorithms recognize text in the landmark features 1276 and associate that text with the features (e.g., in a landmark record for each landmark feature).

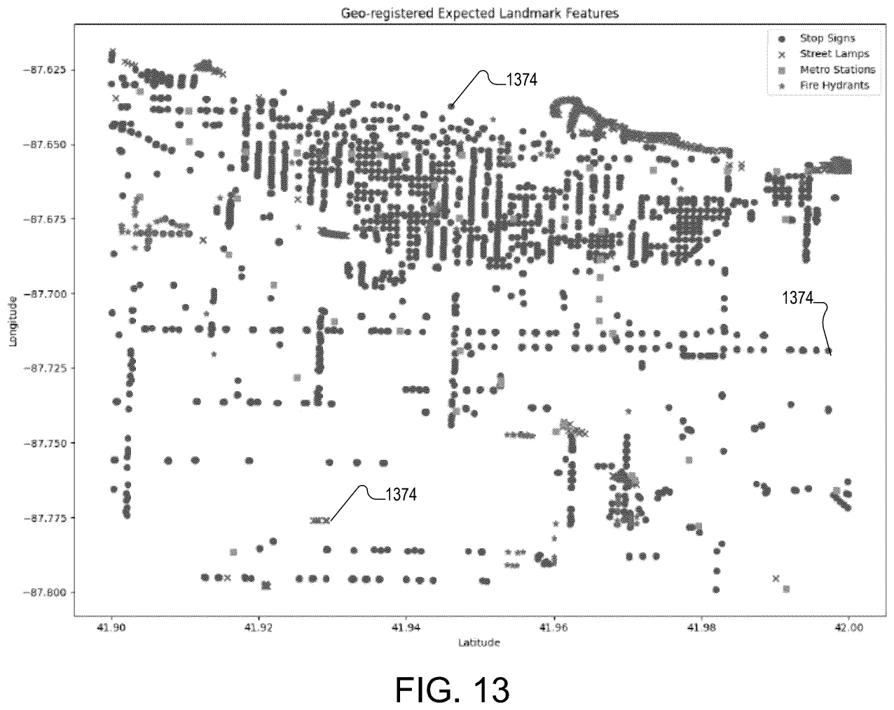

Referring again to FIG. 11, the landmark features 1276 identified by the landmark detection module 1168 are provided to the map formation module 1170 along with pre-processed landmark data 1172 (e.g., from Google Maps or OpenStreetMap). In some examples, the pre-processed landmark data 1172 includes georeferenced labels of landmark features in a region, the features including but not limited to business names, street names, house numbers, traffic lights. For example, referring to FIG. 13, a number of landmark features 1374 from the pre-processed landmark data 1172 are shown as dots located at different latitudes and longitudes in a geographical region. In some examples, each dot is associated with a corresponding landmark record including the following fields:
Location: Latitude & Longitude
Type: Business, stop sign, metro station, etc.
Feature Name: Business name, road name, etc.

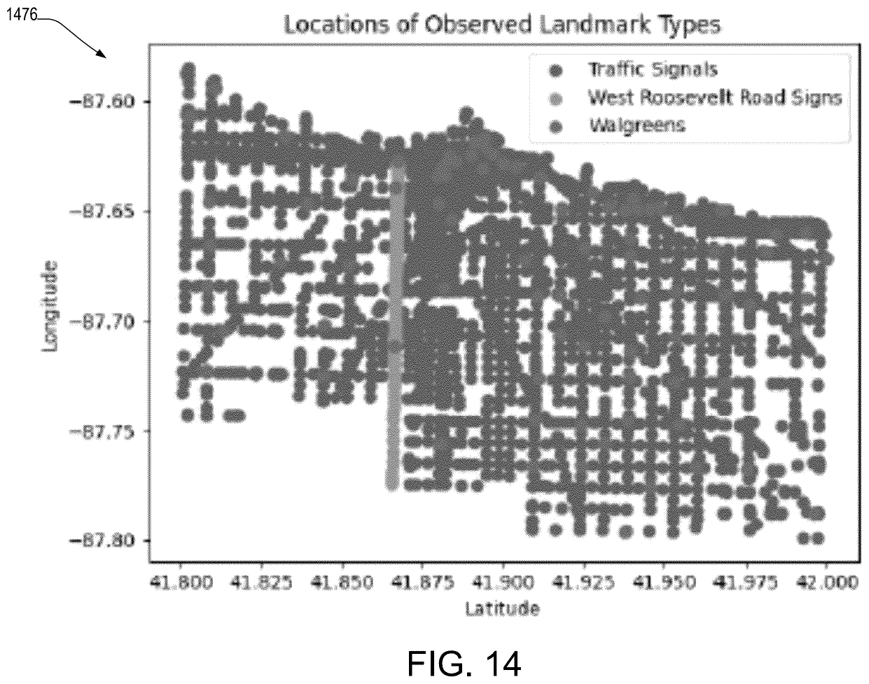

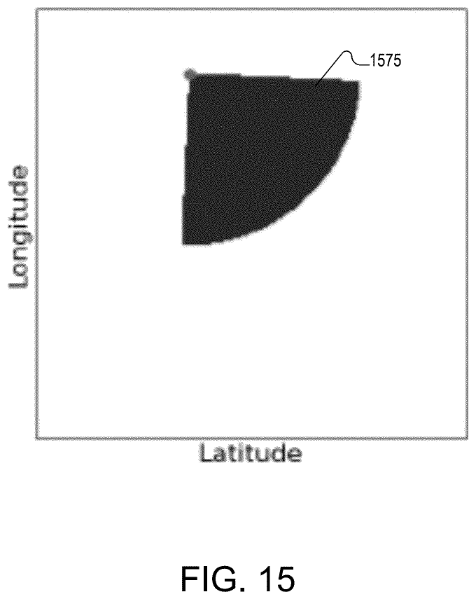

Referring again to FIG. 11, the map formation module 1170 processes the landmark features 1276 identified by the landmark detection module 1168 according to the landmark features in the pre-processed landmark data 1172 to generate a map of possible locations where the landmark features are visible. For example, referring to FIG. 14, the observed landmark features include a traffic signal, a “West Roosevelt” street sign, and a “Walgreens” street sign. A map 1476 of all possible locations where those features can be observed is generated using the pre-processed landmark data 1172. In some examples, each location on the map 1476 is associated with a shape where the drone could possibly see the feature (e.g., a pie-slice shape 1575 with a width related to the camera field of view and length based on plausible visibility, as shown in FIG. 15).

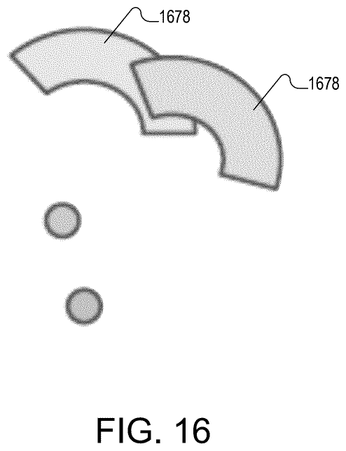

Referring to FIG. 16, in some examples, the shape where the drone could possibly see the features is further refined using sensor data such as LiDAR sensor data. For example, for each observed landmark feature, a bounding box associated with the feature and a depth map (e.g., from a LiDAR sensor) is used to determine how far away the feature is. The depth information is then used to convert the “pie-slices” to arcs 1678, where the angle of the arcs relates to the heading uncertainty and the ranges of distances from the feature location relates to the depth error of the LiDAR sensor.

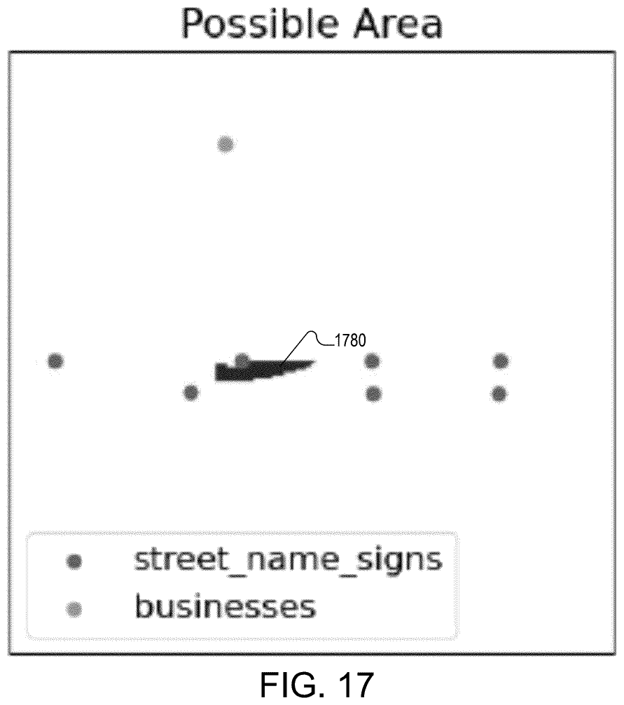

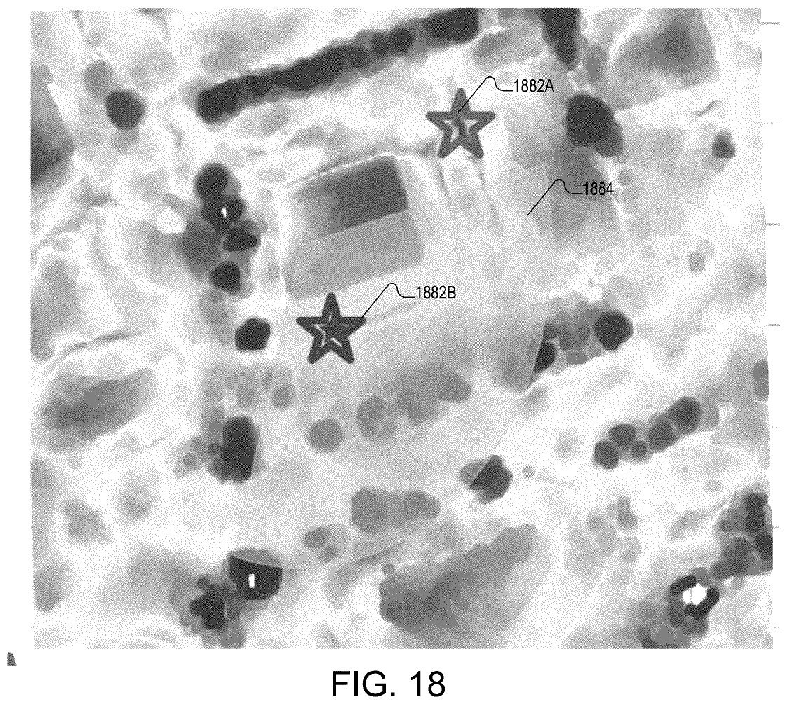

The map formation module 1170 outputs a representation of the map 1476 to the position determination module 1174, which identifies an intersection of all the observed feature types (and their “pie-slices” or arcs) to generate an overlapping region where all observed landmark features could simultaneously be visible. For example, referring FIG. 17, the overlapping region 1780 illustrates a possible region where the drone is located. Ultimately, the position determination module 1174 generates the landmark location VPS data 1126 as output.

In some examples, location data from other visual positioning systems can be used to determine the specific location of the drone. For example, referring to FIG. 18, two location results 1882A, 1882B from the skyline VPS 232 are displayed on a geographic region along with a “pie-slice” 1884 from the map formation module 1170. One of the skyline location results 1882B is located within the “pie-slice” 1884 and is therefore selected as the drone's location because of the agreement of locations between the skyline VPS 232 and the landmark VPS 230. In yet other examples, prior GPS or IMU sensor data can also be used to constrain the georeferenced data considered by the position determination module 1174.

Additional details related to the landmark VPS can be found in section 4 below, titled “Object Localization Detail.”

### 2.3 Skyline VPS

In some examples, the skyline VPS 232 is used as the drone 100 (or other platform) flies as the drone 100 (or other platform) flies or otherwise moves near ground level and between buildings, with its camera 108 facing outward towards the building facades.

As the drone 100 flies, it captures horizontal view image data and the skyline VPS module 232 processes the image data to generate skyline VPS location data. For example, the skyline VPS module 232 detects a skyline in the image data using analytical (i.e., canny) or neural network-based (e.g., segment anything, CNNs) techniques. In some example, the image data is acquired for 360 degrees around the drone and an observed skyline is computed, including elevation for each azimuth (or a dense sampling for azimuths).

The observed skyline is compared to skyline data from a pre-computed database (e.g., a digital surface model (DSM) of an area represented as a 2D grid of altitudes, processed to compute an expected skyline for each location, resulting in a 3D volume). A point where an error between the observed skyline and the skyline from the pre-computed database is smallest is selected as the skyline VPS location data.

In some examples, a multi-resolution data representation is used by the skyline VPS 232, as is described in greater detail in section 5 below, titled “Multi-resolution Data Representation Detail.”

The fundamental operation of the skyline VPS 232 is described in U.S. Pat. No. 11,678,140 (incorporated by reference above) and is not described in further detail here.

Several improvements have been made to the skyline positioning system described in U.S. Pat. No. 11,678,140.

### 2.3.1 Skyline Computation for Flying

For example, when computing the skylines in the pre-computed database of skylines, the skylines may be computed from h-meters of the surface (where h is the height of the drone), rather than assuming that the camera is on the ground.

### 2.3.2 Similarity Score

In other examples, a similarity score is used to compare skylines in a way that is robust to outdated reference data. For example, trees or buildings that were present in the reference data may no longer be present (or vice versa). The similarity score is a way to robustly compare skylines where the reference data has changed.

In some examples, the similarity score is computed as a fusion of squared-error with thresholding. For example, the similarity score “Degree Error” can be calculated as:

$$DegreeError = abs ( precomputedSkyline - observedSkyline )$$

A threshold can then be applied, as follows:
ifDegree Error>5 deg: return 1
   where any value ofDegree Error greater than 5 degrees represents a poor alignment and a similarity score value of 1 is returned.

Otherwise, the similarity score is computed as follows:
else: returnDegree Error/90 deg
   where dividingDegree Error by 90 degrees provides a normalized value. Since 90 degrees represents a worst-case angular misalignment, dividing by 90 degrees ensures that small errors contribute proportionally to the similarity score.

In some examples, when a skyline changes, the effect is a large swing in elevation angle (either more positive or more negative). Some similarity scores penalize the correct location greatly because the observed and expected skyline differ greatly at a few azimuths. For instance, consider a new skyscraper being built where a parking lot once was. Since skylines are generally unique, even when a change occurs before reference data can be updated, the observed skyline will not be found anywhere in the precomputed area. The next best skyline could be one with a shorter building at that view direction. The similarity score described herein penalizes most locations by the same value for that view direction since it thresholds any error worse than 5 deg (a tunable value). Then the parts that are close to being correct (i.e. a skyscraper of similar height and direction) are what matters for selecting a location.

### 2.3.3 Local Neighborhoods

In some examples, using local neighborhoods helps improve positioning accuracy for skyline visual positioning, especially in challenging scenarios like where there is a small field of view (i.e., when only a limited portion of the skyline is visible, it may not be distinctive enough to uniquely determine a location) or in suburban or repetitive landscapes (i.e., in areas with low skyline variability such as areas with rolling hills and small buildings, where multiple locations may appear similar, leading to ambiguity).

In the types of non-distinctive areas described above, the top location matches for skyline visual positioning may have very close similarity scores, making it hard to select the best location. In some examples, the skyline VPS 232 addresses this issue by, instead of relying on a single match, considering neighboring locations and adjusting/weighting the similarity scores based on consistency across nearby points. Doing so can smooth out noise and strengthen location confidence by leveraging spatial continuity.

### 2.3.4 Sensor Fusion

In some examples, the skyline VPS 232 can be improved by using prior GPS or IMU data or location data from the landmark locator VPS 230 to constrain its 2D search. For instance, if prior data indicates a 15-foot movement in the last minute, the search volume is reduced from a 2 km×2 km area to a more manageable 10 m×10 m×10 m volume. In other examples, an altimeter can be used to constrain the search across skyline maps.

### 2.4 Mesh VPS

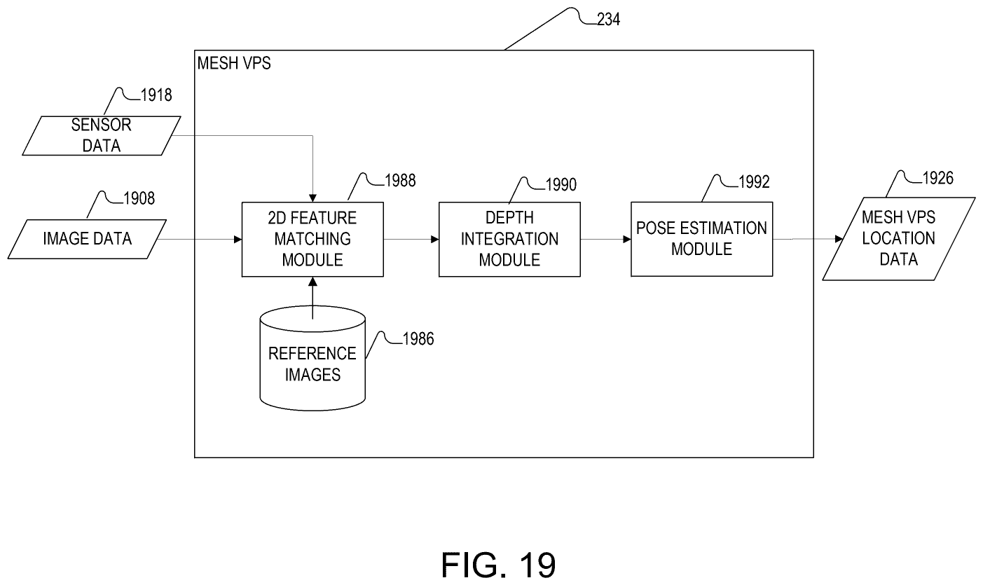

Referring to FIG. 19, in some examples, the mesh VPS 234 is used as the drone 100 (or other platform) flies or otherwise moves near ground level, with its camera 108 facing outward. In general, the mesh VPS 234 is able to obtain centimeter-level localization accuracy in some environments with few restrictions on the camera, as long as a sufficient, rough location is available.

As the drone 100 flies, it captures horizontal view image data 1908 and the mesh VPS 234 processes the image data 1908 to generate mesh VPS location data 1926. In some examples, the mesh VPS 234 includes a database of reference images 1986, a 2D feature matching module 1988, a depth integration module 1990, and a pose estimation module 1992.

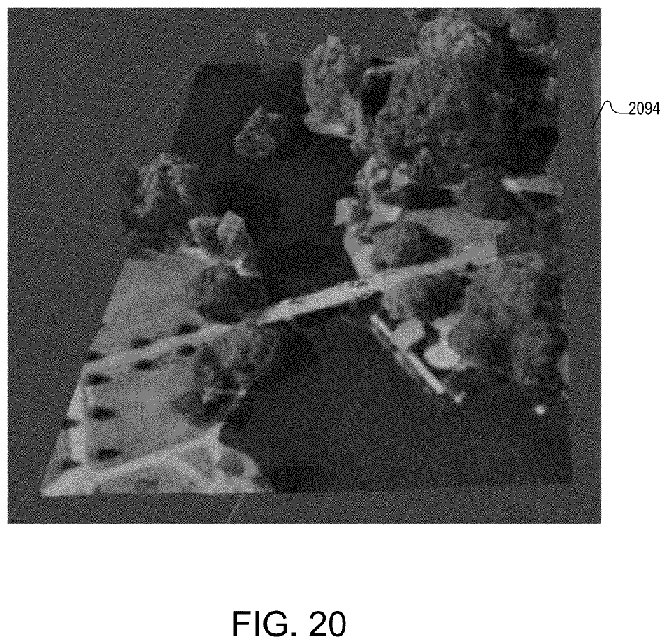

Referring to FIGS. 20-22, in some examples, the database of reference images 1986 is formed by first downloading geo-referenced 3D textured meshes (e.g., FIG. 20, element 2094) for a geographic region (i.e., associated with a rough location of the drone) from a third-party provider (e.g., Google Earth or OpenStreetMap). In some examples, prior sensor data 1918 (e.g., GPS, IMU, altimeter, or landmark VPS location data) can be used to constrain the reference image locations.

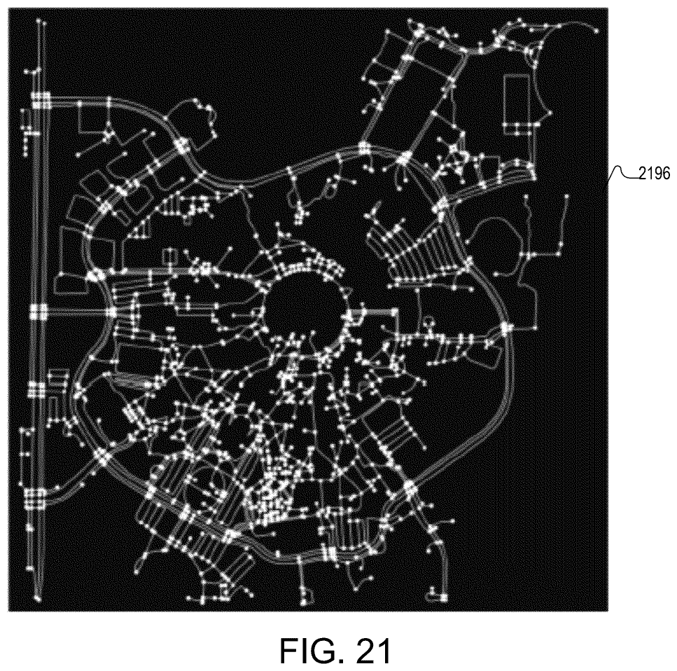

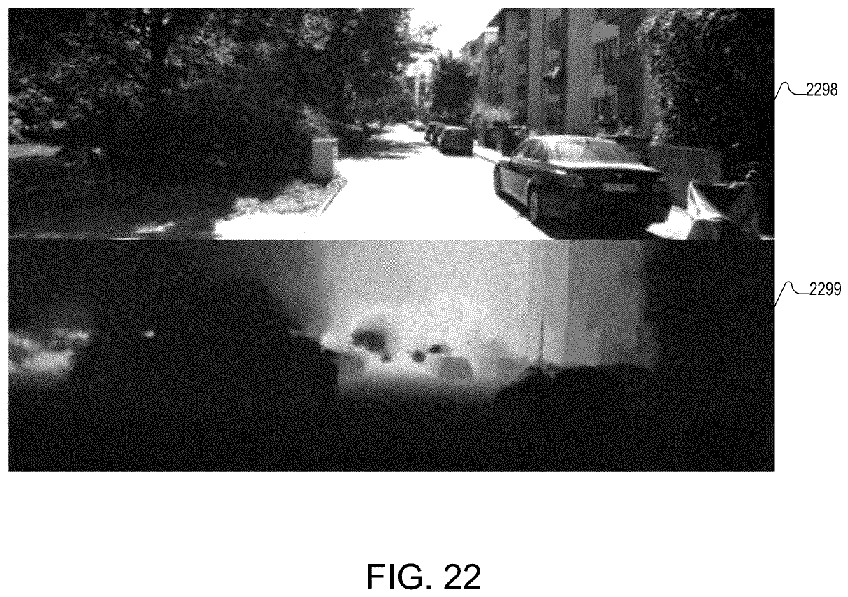

Then a walkable area graph (e.g., FIG. 21, element 2196) is generated for the geographic region using 2D maps (e.g., satellite imagery). Finally, referring to FIG. 22, the 3D textured meshes are used to generate the reference images as RGB images 2298 and depth maps 2299 (e.g., using an engine such as OpenGL or Blender) from different perspectives in the geographic region (e.g., at a dense random sample of walkable points on the walkable area graph).

Referring again to FIG. 19, the database of reference images 1986 and the image data 1908 are provided to the 2D feature matching module 1988, which performs 2D keypoint matching on the image data 1908 and the reference images to identify common visual features between the image data and the reference images (e.g., by matching SIFT/SURF or other keypoint detector descriptors between the image data and the reference images).

The matching features identified by the 2D feature matching module 1988 are provided to the depth integration module 1990, which converts the 2D feature matches into 3D correspondences in the mesh using depth information. For example, for each 2D keypoint match between the image data 1908 and a reference image 2298, a corresponding depth value is retrieved from the reference depth map 2299 associated with the reference image 2298. In some examples, the camera's intrinsic parameters may also be accounted for in converting the 2D feature matches into 3D correspondences in the mesh.

The 2D-3D correspondences for the feature matches are provided to the pose estimation module 1992, which solves for the camera pose using, for example, a perspective-n-point (PnP) algorithm, which finds the best transformation that maps 3D points to the 2D image plane. The pose estimation module 1992 outputs the pose of the camera as the mesh VPS location data 1926.

### 3 Alternatives

Different types of cameras can be used, including but not limited to standard RGB cameras, infrared sensors, or multispectral sensors. Additional sensors can also be integrated into the VPS, including but not limited to LiDAR, RADAR, ultrasonic sensors, IMUs, altimeters, barometers, and any other suitable sensor.

In some examples, the VPS can function using onboard edge AI for real-time applications or cloud-based computing for post-processing.

The VPS can work outdoors using terrain, skyline and landmark detection. It should be recognized that the VPS also works indoors using fiducial markers, signs, and other visual features. In addition to aerial (e.g., drone) deployments of the VPS, the VPS can also be implemented in ground vehicles, wearable devices such as AR/VR headsets, and robots. VPS can enable autonomous operations for cars, trucks and robot through precise geolocation delivered on the edge or through a 5G/6G cellular or Wi-Fi connection. It can also complement location delivered through Real-time kinematic positioning (RTK).

### 3.1 Examples of Operation

While the above description is written in the context of an aerial drone flying from a starting position to a starting position, it should be appreciated that there are many applications of the described VPS.

For example, autonomous drones can use the VPS for package delivery in urban canyons where GPS signals are weak. The VPS may enable secure positioning for soldiers in environments where adversaries may jam GPS. The VPS may be deployed in disaster recovery and search and rescue context, where VPS-equipped drones are deployed in affected areas (e.g., earthquake or fire areas), where GPS infrastructure may be unreliable. The VPS may also be used to guide munitions to a target.

The VPS is also usable in deep space navigation, where the VPS is implemented on rovers exploring planetary services (e.g., Mars or the Moon), where GPS is unavailable. The VPS may be integrated into augmented reality (AR) devices to provide location-based information indoors or in dense urban areas.

In some examples, the VPS is adaptive and selects visual-positioning subsystems to use based on the qualities of the image data available in the environment.

### 3.1.1 Unreliable Ground Localization Workflow

In some areas, visual ground localization is near-impossible such as in rural areas (where there is missing reference data or a lack of unique features). In these cases, the system can detect when the ground-based VPS (e.g., skyline, landmark, and mesh VPS) is unreliable, and request the drone to ascend above buildings to re-calibrate its location.

### 3.1.2 Unreliable Aerial Localization Workflow

In areas of extreme uniformity such as planned neighborhoods, the aerial VPS may struggle since many features repeat. In these environments, the system can cause the drone to descend between buildings to pick up on ground-level variability (e.g., painted houses, street names, building numbers).

A number of additional features that may be incorporated are described below.

### 3.2 Detecting GPS Jamming/Spoofing:

The solution may work together to detect GPS jamming and spoofing as follows:

### 3.2.1 Signal Strength Analysis

This first layer of defense against GPS interference involves monitoring the signal-to-noise ratio (SNR) of the GPS signals received by the device's GPS receiver. A sudden spike in SNR could be indicative of jamming efforts, where an adversary attempts to drown out the GPS signals with noise. Conversely, inconsistent SNRs across different channels may hint at spoofing attempts, where false signals are sent to mislead the receiver. This analysis can trigger alerts or switch the device to rely more on alternative data sources for positioning.

### 3.2.2 Consistency Check Between Multiple Sensors

Data fusion techniques play a critical role here, as they enable the system to check for consistency between the data provided by the GPS receiver, the IMU, and the barometer. These sensors offer complementary information: the GPS for location, the IMU for movement and orientation, and the barometer for altitude. Sudden mismatches or inconsistencies among these data sources might signal that the GPS data is compromised, prompting the system to adjust its reliance on GPS and instead weight other data sources more heavily.

### 3.2.3 Carrier Frequency Analysis

This technique involves analyzing the carrier frequency of the incoming GPS signals. Since GPS spoofing attempts often involve broadcasting signals that mimic genuine GPS frequencies, slight shifts from the expected carrier frequency can be a telltale sign of spoofing. Detecting these shifts can help in early identification of spoofing attempts, enabling the system to disregard suspect signals.

### 3.2.4 Time-to-First-Fix (TTFF) Monitoring

Monitoring how long it takes for a GPS lock (TTFF) will provide insight into the health and reliability of the GPS signal. An unusually long TTFF might suggest that the device is experiencing jamming, as the interference prevents the receiver from locking onto the satellite signals efficiently. Recognizing this, the system will automatically switch to alternative positioning methods and also inform the user about this change.

### 3.2.5 Phase Anomaly Detection

By detecting anomalies in the carrier phase of GPS signals, the system will identify sophisticated spoofing attempts that might not significantly affect signal strength or frequency. Phase anomalies, which might be subtle, are indicative of manipulated signals. This detection adds another layer of security by identifying and mitigating more sophisticated threats.

3.2.6 Cross-Checking with Visual Landmarks

Integrating computer vision will elevate the resilience of the navigation system. By using the camera to identify known landmarks and comparing their observed positions against expected GPS data, the system will validate the authenticity of the GPS information. Discrepancies between the visual identification of landmarks and GPS data could indicate spoofing. This method not only provides a way to confirm the integrity of GPS data but also offers an alternative positioning method when GPS data is deemed unreliable.

### 3.3 Identifying Positioning in the Absence of GPS Using Terrain Features

A solution may leverage camera sensor available on iPhone and Android devices to automatically identify and match terrain features, when they exist (primarily in urban, coastal and suburban areas). Such solutions may operate as follows:

### 3.3.1 Imagery Acquisition

The camera on a cellphone captures images of the surrounding environment. These images serve as the primary input for the positioning technology. Modern smartphones are equipped with high-resolution cameras capable of capturing detailed landscape features under various lighting conditions. When a user initiates the positioning function, the camera automatically adjusts its settings (focus, exposure, ISO) to optimize the image quality for subsequent processing steps. A user may be given the option to take a panoramic image (which is automatic stitching of multiple images) to have a larger Field of View (FOV) for the system to localize more accurately and efficiently.

### 3.3.2 Skyline Segmentation

Once an image is captured, the first computational step involves skyline segmentation. This process identifies and isolates the outline of the terrain features (such as mountains, buildings, and trees) from the sky. Segmentation algorithms, particularly those based on deep learning, are employed for this task. Convolutional Neural Networks (CNNs) are a common choice due to their efficacy in image recognition and segmentation tasks. The algorithm processes the image, identifying edges and contrasts that delineate the skyline from the rest of the image. Techniques such as semantic segmentation can be applied, where each pixel in an image is classified as belonging to the skyline or not. This is achieved through training the model on a dataset of images with labeled skylines. Advances in deep learning allow these operations to be performed efficiently on-device, leveraging the increasingly powerful GPUs and neural engine co-processors found in modern smartphones.

### 3.3.3 Matching Skyline Against DSM Datasets

The segmented skyline is then matched against a pre-existing digital surface model (DSM) dataset. DSMs are 3D representations of the earth's surface, including all objects on it. They provide a detailed view of the terrain features at various locations. The matching process involves comparing the segmented skyline from the camera image with the silhouettes of terrain features derived from the DSMs. This comparison can be achieved through various algorithms, including feature matching and template matching techniques. Feature matching involves identifying distinctive features in the segmented skyline and comparing these features with those in the DSM silhouettes. Template matching, on the other hand, involves sliding the segmented skyline across the DSM silhouette and measuring the similarity at each position to find the best match.

### 3.3.4 Location Estimation

Once a match is found, the system can estimate the user's location based on the known coordinates of the matched terrain feature in the DSM dataset. Advanced algorithms can also take into account the angle and orientation of the camera, derived from the smartphone's onboard sensors, to improve the accuracy of the location estimation.

Such processes do not require GPS, Wi-Fi, or cellular connections, as they can rely solely on the camera imagery and pre-loaded DSM datasets. The entire process, from imagery capture to location estimation, is performed on the edge (i.e., directly on the device), leveraging the computational power of modern smartphones.

The localization can be done without the need for a constant connection to the internet and only rely on reference data that is available on the device.

3.3.5 Identifying Positioning in the Absence of GPS without Using Terrain Features Through IMU-Based Multi-Label Deep Neural Networks

An IMU sensor available on iPhone and Android devices may be leveraged to identify changes in motion, orientation, and acceleration, especially in the absence of terrain features (rural areas, open ocean, flat terrains due to bombardment etc.). While IMUs have drift, it can be correct over time by utilizing terrain features highlighted above, when they are available. IMU drift on cellphones is particularly bad since the IMUs on commercially available cellphones are generally cheaper and more-error prone than more expensive IMUs in cars, robots and aircraft. Here's how this approach will work:

3.3.6 Data Acquisition from IMU Sensors

The Inertial Measurement Unit (IMU) on a cellphone consists of accelerometers, gyroscopes, and barometric pressure sensors. These sensors provide data on the device's acceleration, angular velocity, and atmospheric pressure, respectively. This data is crucial for estimating the device's motion and orientation.

### 3.3.7 Multi-Label Deep Neural Network Architecture

To process data from the IMU sensors, a multi-label deep neural network architecture is employed. This architecture is designed to perform multiple tasks simultaneously, such as estimating the device's position, velocity, and orientation. The network uses layers of temporal convolutional neural networks (TCNNs) combined with self-attention mechanisms to process the sequential sensor data effectively. The TCNN layers are adept at handling time-series data, capturing temporal dependencies in the sensor readings. The self-attention mechanism allows the network to focus on relevant parts of the sensor data sequence, improving the accuracy of the estimation.

### 3.3.8 Trajectory Estimation Algorithm

The trajectory estimation algorithm predicts the device's position and orientation in both spherical coordinates and quaternion representations. This dual representation ensures compatibility with various application requirements. The algorithm takes raw data streams from the accelerometer, gyroscope, and magnetometer, and processes them through the multi-task TCNN with self-attention. This approach allows for the accurate estimation of the device's 6-degrees of freedom position and orientation, even in the absence of external reference points like GPS signals. The trajectory estimation is crucial for navigation and positioning tasks, especially in environments where GPS signals are unavailable or unreliable.

### 3.3.9 Adversarial Learning Inspired Feature Denoising

To enhance the robustness and accuracy of the positioning technology, an adversarial learning-inspired feature denoising algorithm is implemented. This algorithm is designed to remove noise from the sensor data, which can significantly impact the accuracy of the position and orientation estimates. By learning to distinguish between useful signal and noise, the algorithm improves the quality of the sensor data fed into the neural network. This denoising process not only enhances the accuracy of the trajectory estimation but also contributes to the overall reliability of the positioning technology in challenging environments.

### 3.4 Providing Navigation in the Absence of GPS

A solution for identifying navigation in the absence of GPS may combine the positioning information gathered from camera imagery, and Inertial Measurement Unit (IMU) data. This process will involve several steps designed to ensure accurate and reliable navigation without relying on GPS signals. Here's how the navigation component will operate:

### 3.4.1 Fusion of Positioning Data

The first step involves fusing the positioning data obtained from the camera (skyline-based location estimation) and the IMU (trajectory estimation). This data fusion is accomplished using advanced algorithms such as Kalman filters and particle filters, which integrate the data from different sources to produce a more accurate estimate of the device's current location and orientation. These filters will be particularly effective in dealing with the inherent noise and uncertainties in sensor data.

### 3.4.2 Path Planning and Route Generation

Based on the fused location and orientation data, the system will then generate a path or route to the desired destination. This will involve using algorithms that can calculate the most efficient route based on the current position, taking into account any known obstacles, terrain features, or other relevant environmental data stored in the device's memory or accessible from pre-loaded maps. The route generation algorithm will adapt to changes in the user's location and orientation, recalculating the route as necessary.

### 3.4.3 Real-Time Navigation Guidance

The navigation system will provide real-time guidance to the user, displaying the generated route on the device's screen and offering audio or visual instructions for direction changes, similar to conventional GPS-based navigation systems. This guidance will rely on the continuous update of the user's position and orientation, ensuring that the directions remain accurate and relevant as the user moves.

3.4.4 Integration with Additional Sensors

Besides the camera and IMU, the system will also integrate data from a barometer (altitude data), which will be particularly useful in hilly or remote mountainous terrains. Similarly, a magnetometer will offer additional orientation cues by measuring the Earth's magnetic field, providing a form of electronic compass.

### 3.4.5 Adaptive Sensor Utilization

The system dynamically adjusts the reliance on different sensors based on their availability and the quality of the data they provide. For instance, in environments where visual landmarks are not discernible (e.g., foggy or indoor settings), the system will rely more heavily on IMU data. Conversely, in visually rich environments, camera-based navigation can take precedence, with IMU data providing supplemental information to correct for drift or temporary occlusions.

### 3.4.6 User Feedback and System Learning

The navigation system will also incorporate mechanisms for user feedback, allowing it to learn from any navigation errors or inaccuracies reported by the user. This feedback will be used to refine the data fusion algorithms and improve the accuracy of the path planning and guidance systems over time.

For the sake of exposition, unless otherwise clear from context, a “location” of an object or feature refers to its horizontal coordinates (e.g., “x-y”, latitude/longitude, map grip etc.), a “height” or “altitude” (generally used interchangeably) refers to its vertical coordinate (e.g., with reference to a standard reference), and “position” is used to refer to the combination of location and height (e.g., specified by 3D coordinates). An “elevation” of an object at a first location (i.e. at a first position) relative to a second position (e.g., an observation position), refers to an angle relative to (positive when above) a reference plane through the second position. An “azimuth” is an angular direction in a reference horizontal plane relative to a reference direction (e.g., true north), recognizing that in many localization situations, this reference direction may be unknown and therefore only “relative azimuth” may be known between directions.

A “Digital Surface Model (DSM)” refers to a data structure that stores or otherwise represents height/altitude data of an environment as a function of location (e.g., latitude/longitude), from which an elevation (i.e., angle above a horizontal plane) may be determined from an observation position to the position of a feature in the environment. The DSM may include data such as 3D building data in urban environments, topographic data in non-urban environments, and specific height data for particular features in the environment (e.g., a height of a radio tower at a known location). Such a DSM could for example be derived from a full 3D model of an area.

“Semantic Location Data (SLD)” refers to a data structure that stores or otherwise represents the presence of objects or classes of terrain (foliage, manmade structure etc.) in an environment. In an example of such a data structure, each object is associated with a position (i.e., x, y, z) and a representation of the object or equivalently, each position in an image (e.g., each pixel) is assigned to a specific class of object. Various embodiments may have different representations of the object, including without limitation, a categorization as one of a known object types (e.g., fire hydrant, traffic light, power lines, street signs, terrain classification etc.), or in a numerical representation such as a numerical vector, for example, as determined as a Machine Learning (ML) embedding of the object. Characteristics such as size, color, etc., may be represented explicitly or implicitly (e.g., in the embedding) in the SLD.

### 4 Object Localization Detail

In a simplified example, the Sematic Localization Data (SLD) may include locations of fixed objects for instance all fire hydrants and mailboxes in an urban environment or even type of terrain. For the sake of discussion below, such objects may be referred to as “semantic objects” without intending to introduce any connotation arising from the word “semantic.” The localization device includes a semantic object locator such that after acquiring an image the object locator finds the objects in the image and determines azimuth and elevation (and optionally range) of the fire hydrants and mailboxes in the image from the device's position (e.g., using a ML (e.g., a convolutional neural network) image detector trained on examples of fire hydrants and mailboxes). In principle, the SLD may be consulted to determine a position of the device that is consistent with the detected objects to determine an exact position from with the image was acquired.

Rather than using the detected objects (i.e., the angles from the device to the object) to determine a position of the device, the detected objects may be used to determine a candidate set regions in which the device may be (e.g., specified as either 2D or 3D regions). For example, a geographic area may be divided into squares (or cubes, or other 2D or 3D rectilinear regions), and for each square, a minimum and maximum count of the number of fire hydrants and mailboxes visible from any position in the square may be precomputed. Once the number of fire hydrants and mailboxes that were actually detected are known, at least some square may be excluded as being inconsistent with the object detection.

There are yet other ways of using the object detection information to more precisely narrow down to the possible position of the device, for example, using specific locations of objects, angles between pairs of objects, solid angle spanning the objects, etc.

In another use of object detection, the objects are used in conjunction with a matching of skyline, such that a combined accuracy is determined by combining a match of the detected skyline to the expected skyline from a particular device position along with a match of detected objects relative to the detected skyline to the expected object positions. For example, the skyline provides one score and the objects provide another score, and the scores are added. Confidence metrics (to pick one over the other) can also be leveraged if the skyline and detected object approaches give obvious competing results.

As introduced above, “semantic features” or “semantic objects” refer to elements within an image that can be identified using object detection algorithms, such as ‘You Only Look Once’ (YOLO).

In situations where multiple semantic features are detected at the same azimuth angle, it may be useful to record not only their count but also the range of their elevation angles. This data can then be utilized to differentiate between features based on their specific azimuth angles. The overarching aim is to represent the scene in a manner that allows for sparse precomputation, thereby optimizing the efficiency of the matching algorithm. This approach moves away from pixel-based comparisons to a more streamlined method, potentially using vector features for each azimuth angle.

Ultimately, the goal is to align a singular feature—whether it pertains to elevation, semantic objects, depth, or another aspect—with another dimension. This alignment enables a rapid and efficient matching process against new images, facilitating quick searches and comparisons.

It is not required that the vectors may be a function of azimuth, but it can be any dimension that spans the space coupled with that particular feature value Such as reduced forms of features like elevation angle or skyline depth of skyline object presence of object like a fire hydrant, street signs, windows etc. One might extend the dimension of iteration from azimuth to azimuth and bottom pitch to upper pitch e.g., 90 to zero and then 0 to 90 and have the azimuth act as the independent variable across the dimensions.

Furthermore, as before, one can capture an image and restrict the comparison as necessary such as based on Field of View (FOV) of camera or visually based reduction which is covered by prior skyline case but now extended the dimension to depth, presence or number of semantic objects, type of terrain one expects to see etc.

Furthermore, one can imagine the matches being at least some combination of independent metric per features compared across the common (e.g. azimuth) dimension. Thus one could use an energy metric or a true false match compared value at first dimension or any other well-known metric with associated bias. In this way we do a multidimensional ordering comparison. The advantage is that although reducing to features may alias or misorder the true location but adding extra dimensions further corrects this misordering.

A multidimensional approach using this skyline framework is posited here which allows one to utilize other a priori information which could include not just the DSM but the placement of different kinds of objects in the worlds. We can then, based on that a priori information, do the very same projections onto the coordinate system resulting in a vector representing angular view around a point indexed by angle that can easily be matched against based on taking an image. For example, a bit vector may be used for each angle with a particular bit representing that there is a fire hydrant on the line of that angle in the image.

### 5 Multi-Resolution Data Representation Detail

In one multiresolution data implementation, a quadtree data structure is used in the DSM to represent height as a function of location. This structure is used to maintain greater precision of location and/or height near an object to be localized that more remotely. In an exemplary example, to represent height relevant to localization on a city street in Seattle, building 3D models may have a high precision in the vicinity of the device's location, while distant topographic features (e.g., Mt. Rainier) may have lower precision. It should be noted that although the precision of the elevation of the peak of the mountain may be lower for a distant mountain than for a nearby building, the precision of the impact on elevation and azimuth may be commensurate. More generally, there may be little benefit from maintaining the same precision for the entire visible range from a device.

In a particular embodiment, a quadtree data structure is used and accessed during the localization process, with generally closer regions to the expected location of the device being represented at higher resolution than the more distant locations. Notwithstanding the differences in resolution a computed skyline from a putative position of a device with have relatively uniform accuracy in elevation as a function of azimuth.

Note that the quadtree representations may be used not only for the DSM but may also be used for the SLD. In some examples, the SLD is only used for nearby regions because the objects of interest are generally close to the device's location.

In some examples, the skylines are computed by constructing the 3D representation, first using the highest definition one for a small piece that we download then the remaining going outward using lower scale versions as you move out from the center. The point being when you then take the constructed 3D mesh the results are computed using the different scales.

In the discussion above a specific yaw pitch and roll is used, but because of “noise” the search space is expanded so that, for example, to look for lowest distance iterating over the 3 dimensions over a limited range. So the exact yaw pitch and roll are not required (e.g., with 180 degrees in each direction around an azimuth do the computation and if there is enough uniqueness then we don't need to input an azimuth in our match, do the search across all 360 degrees shifting it one degree at a time to see which one gives us the best result). Similarly for 5% roll and pitch changes one can iterate. So, the predicted values can be different.

Also, if the altitude and the elevation angle and distance to a skyline is known, we can search in the “z” dimension (altitude for example). This is done by transforming the predicted skyline, understanding what it might look like if the “z” dimension were above the skyline computed for the “z” on the Digital Surface Model (DSM).

### 6 Integration with Other Localization Modalities Detail

In a number of embodiments, the device may not rely solely on skyline-based localization. For example, the device may have a GPS receiver that may not provide accurate positioning but may be useful for gross localization. The device may have an inertial measurement unit (IMU), which may be useful for near time/space movement but not be as useful when having to integrate over long time or space. The device may make use of visual odometry, for example to sense movement. Yet other localization and/or movement sensors may be available.

In such embodiments, it should be recognized that between successive image acquisition for the purpose of skyline and/or object localization, such additional devices may provide an estimate of the movement of the device since the previous skyline acquisition. Therefore, the range of exhaustive search of device positions to match the skyline in the acquired image may be greatly reduced. For example, without such sensors, a range within a prior position may be determined based on a maximum speed and unknown direction. With the sensors, only a small part of such a range may need to be searched.

Similarly, having determined an accurate location using skyline localization, the location may be fed back to the other sensor systems, for example, to correct aspects such as drift in an IMU, or as an additional measurement in a tracking system, for example, implemented as a Kalman Filter or an Extended Kalman Filter.

Furthermore, in some examples, the detection of objects in the field of view may be fed back to an integrated Simultaneous Localization and Mapping (SLAM) to determine locations of objects (e.g., fire hydrants) if a prior and up-to-date SLD is not available.

Integration of computer vision with inertial sensors to provide a robust alternative to GPS, ensuring reliable positioning and navigation even in areas with poor or no GPS connectivity. The system leverages the existing sensors on modern smartphones, including cameras and Inertial Measurement Units (IMUs), to deliver precise real-time PNT data. Some examples of such integration include:

### 6.1 GPS Jamming/Spoofing Detection:

As is described above, the system can employ multiple strategies to detect GPS interference. It utilizes signal strength analysis, consistency checks across sensors, carrier frequency analysis, Time-to-First-Fix (TTFF) monitoring, phase anomaly detection, and cross-checking with visual landmarks. These methods collectively enhance the system's ability to identify and mitigate GPS spoofing and jamming attempts, ensuring the integrity of the PNT data.

6.2 Positioning with Terrain Features:

Utilizing camera sensors, the system captures imagery to identify and match terrain features against a pre-existing reference dataset such as a Digital Surface Model (DSM) dataset. Through skyline segmentation and matching algorithms, it accurately estimates the user's location in environments rich in terrain features, independent of GPS, Wi-Fi, or cellular connections.

### 6.3 IMU-Based Positioning in Featureless Terrains:

In the absence of distinct terrain features, the system relies on data from IMU sensors processed through a multi-label deep neural network architecture. This approach enables precise trajectory estimation and positioning by effectively handling sensor data noise and drift, crucial in environments such as rural areas or open ocean.

6.4 Navigation without GPS:

The system integrates positioning data from both camera imagery and IMU sensors to provide accurate navigation. It employs data fusion techniques, path planning algorithms, and real-time navigation guidance, adjusting sensor reliance dynamically based on environmental conditions and data quality. Additional sensor integration, such as barometers and magnetometers, enhances the system's versatility and accuracy.

Some of such integrations may enhanced reliability and accuracy in GPS-challenged environments. Its adaptive, sensor-fusion approach, leveraging the ubiquitous smartphone platform, sets a new standard for future PNT solutions, making it a valuable tool for a wide range of applications in both civilian and military sectors.

This invention relates to geographic localization using skyline sensing (identification and matching), semantic segmentation (object detection), identification of timings, data fusion (with other sources of localization data including inertial) and identification of GPS jamming, spoofing and degradation.

### 7 Implementations

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for localizing a device comprising:
acquiring image data from a device, the image data including:
data representing a skyline visible from the device at a position of the device in an environment, and
data representing instances of objects from a plurality of classes of objects in the environment;
determining a first position estimate for the device, the determining including:
computing data representing expected skylines at one or more putative positions for the device,
matching the data representing the skyline visible from the device with the expected skylines at the putative positions of the device, and
determining the first position estimate for the device based on a best-matching putative position;
determining a second position estimate for the device, the determining including:
accessing an object model representing locations of instances of objects from the plurality of classes of objects in the environment,
computing data representing the presence of the instances of the objects in the acquired image data,
computing data representing expected object locations visible from the one or more putative positions for the device, and
determining the second position estimate for the device, including matching the data representing the presence of the instances of the objects and the data representing expected object locations; and
determining a combined position estimate for the device based at least in part on the first position estimate for the device and the second position estimate for the device.

2. The method of claim 1 wherein computing the data representing the presence of the instances of the objects includes performing text recognition on parts of the image data associated with at least some of the instances of the objects to generate text data associated with those instances, and determining the second position estimate is further based on the text data.

3. The method of claim 1 wherein the first position estimate is used to access the object model.

4. The method of claim 1 wherein the second position estimate is used to compute the data representing expected skylines at the one or more putative positions for the device.

5. The method of claim 1 wherein the image data from the device further includes nadir-view aerial imagery of the environment and the method further comprises determining a third position estimate for the device, the determining including:
accessing geo-referenced satellite image data representing locations of keypoints in the environment;
computing data representing the locations of keypoints in the acquired image data; and
determining the third position estimate for the device, including matching the locations of keypoints in the acquired image data and the locations of the keypoints in the go-referenced satellite image data;
wherein determining the combined position estimate for the device is further based on the third position estimate data.

6. The method of claim 1 wherein the image data from the device further includes nadir-view aerial imagery of the environment and the method further comprises determining a third position estimate for the device, the determining including:
computing data representing the locations of keypoints in the acquired image data; and
determining the third position estimate for the device, including tracking the located keypoints in the acquired image data over time;
wherein determining the combined position estimate for the device is further based on the third position estimate data.

7. The method of claim 1 wherein matching the data representing the skyline visible from the device with the expected skylines at the putative positions of the device includes computing a similarity score.

8. The method of claim 7 wherein to account for changes in the expected skylines.

9. The method of claim 7 wherein matching the data representing the skyline visible from the device with the expected skylines at the putative positions of the device includes weighting similarity scores in a neighborhood of similarity scores based on a consistency of similarity scores across the neighborhood.

10. The method of claim 1 wherein determining the combined position estimate for the device is further based on data from one or more of an inertial measurement unit, a global positioning system, an altimeter, and a barometer.

11. The method of claim 1 wherein the image data from the device further includes ground-level imagery of the environment and the method further comprises determining a third position estimate for the device, the determining including:
receiving geo-referenced three-dimensional mesh data;
processing the geo-referenced three-dimensional mesh data to generate a plurality of reference images, each reference image including depth information and being associated with data representing locations of keypoints in the reference image;
computing data representing the locations of key points in the acquired image data;
matching the locations of keypoints in the acquired image data to the locations of keypoints in the reference images; and
determining the third position estimate for the device, based at least in part on the matches between the keypoints in the acquired image data and the keypoints in the reference frame, and the depth information in the reference images;
wherein determining the combined position estimate for the device is further based on the third position estimate data.

12. The method of claim 1 wherein the device is an unmanned aerial vehicle.

13. The method of claim 1 wherein the device is an autonomous ground vehicle.

14. A method for localizing a device comprising:
acquiring image data from a device, the image data including data representing a skyline visible from the device at a position of the device in an environment;
accessing surface model the environment;
computing data representing expected skylines at one or more putative positions for the device;
matching the data representing the skyline visible from the device with the expected skylines at the putative positions of the device; and
determining a position of the device based on a best matching putative position;
wherein the method further comprises:
accessing the surface model by accessing a multi-scale representation of three-dimensional characteristics of the environment, including accessing the representation at a plurality of resolutions, including accessing three-dimensional characteristics for a first region at a first resolution and accessing three-dimensional characteristics for a second region at a second resolution different from the first resolution;
computing the data representing expected skylines includes combining expected skylines determined from the three-dimensional characteristics for the first region and the three-dimensional characteristics for the second region.

15. A method for localizing a device comprising:
acquiring image data from a device, the image data including data representing a skyline visible from the device at a position of the device in an environment and locations of objects of a plurality of classes of objects visible from the device;
accessing surface model the environment;
accessing an object model representing locations of objects of the plurality of classes of objects in the environment;
computing data representing expected skylines at one or more putative positions for the device;
computing data representing expected object locations visible from the one or more putative positions for the device matching the data representing the skyline visible from the device with the expected skylines at the putative positions of the device;
matching the data representing the presence of the instances of the objects and the data representing expected object locations; and
determining a position of the device based on a best matching putative position;
wherein the method further comprises:
accessing at least one the surface model and object model include accessing a multi-scale representation of said model, including accessing the representation at a plurality of resolutions, including accessing three-dimensional characteristics for a first region at a first resolution and accessing three-dimensional characteristics for a second region at a second resolution different from the first resolution; and
at least one of the computing the data representing expected skylines and the computing data representing expected object locations includes using the multi-scale representation.

16. A method for localizing a device comprising:
acquiring image data from a device, the image data including data representing a skyline visible from the device at a position of the device in an environment;
accessing surface model the environment;
computing data representing expected skylines at one or more putative positions for the device;
matching the data representing the skyline visible from the device with the expected skylines at the putative positions of the device; and
determining a position of the device based on a best-matching putative position;
wherein the method further comprises:
acquiring localization data from one or more sensors;
determining the position of the data using both the matching of the data representing the skyline visible from the device and the expected skylines at the putative positions of the device and the localization data from the one or more sensors.

17. The method of claim 16 wherein the one or more sensors includes an inertial measurement unit.

18. The method of claim 16 wherein the one or more sensors includes an altimeter.

19. A system for localizing a device comprising:
an input for acquiring image data from a device, the image data including:
data representing a skyline visible from the device at a position of the device in an environment, and
data representing instances of objects from a plurality of classes of objects in the environment;
one or more processors configured to
determine a first position estimate for the device, the determining including:
computing data representing expected skylines at one or more putative positions for the device,
matching the data representing the skyline visible from the device with the expected skylines at the putative positions of the device, and
determining the first position estimate for the device based on a best-matching putative position;
determine a second position estimate for the device, the determining including:
accessing an object model representing locations of instances of objects from the plurality of classes of objects in the environment,
computing data representing the presence of the instances of the objects in the acquired image data,
computing data representing expected object locations visible from the one or more putative positions for the device, and
determining the second position estimate for the device, including matching the data representing the presence of the instances of the objects and the data representing expected object locations; and
determine a combined position estimate for the device based at least in part on the first position estimate for the device and the second position estimate for the device.

20. A non-transitory machine-readable medium having instructions stored thereon, wherein execution of the instructions causes a processor to perform all the steps of a method for localizing a device including causing the processor to:
acquire image data from a device, the image data including:
data representing a skyline visible from the device at a position of the device in an environment, and
data representing instances of objects from a plurality of classes of objects in the environment;
determine a first position estimate for the device, the determining including:
computing data representing expected skylines at one or more putative positions for the device,
matching the data representing the skyline visible from the device with the expected skylines at the putative positions of the device, and
determining the first position estimate for the device based on a best-matching putative position;
determine a second position estimate for the device, the determining including:
accessing an object model representing locations of instances of objects from the plurality of classes of objects in the environment,
computing data representing the presence of the instances of the objects in the acquired image data,
computing data representing expected object locations visible from the one or more putative positions for the device, and
determining the second position estimate for the device, including matching the data representing the presence of the instances of the objects and the data representing expected object locations; and
determine a combined position estimate for the device based at least in part on the first position estimate for the device and the second position estimate for the device.
